(19) United States
(12) Patent Application Publication
(10) Pub. No.: US 2023/0319563 A1
(43) Pub. Date: Oct. 5, 2023

(54) RENEWING VENDOR CERTIFICATES IN A NETWORK

(71) Applicant: Nokia Solutions and Networks Oy, Espoo (FI)

(72) Inventor: Bharath SRIRAM, Bangalore (IN)

(21) Appl. No.: 18/042,127

(22) PCT Filed: Aug. 18, 2021
(86) PCT No.: PCT/IB2021/057577

§ 371 Date: Feb. 17, 2023

(30) Foreign Application Priority Data
Aug. 18, 2020 (IN) 202041035622

(51) Int. Cl. H04W 12/069; H04W 12/71

(52) U.S. Cl. CPC H04W 12/069; H04W 12/71

(57) ABSTRACT

Approaches for renewing a digital vendor certificate of a network device, over a communication network, are described. In one example, a network device may generate and transmit a renewal request with network device attributes and a vendor certificate to a centralized server. The network device attributes may include a Secure Device Identity of the network device. The centralized server, on receiving the renewal request, may derive the network device attributes and the vendor certificate, and may then process the request to authenticate the network device. Upon successful authentication, the centralized server may generate a renewed vendor certificate and transmit it to the network device. The network device, on receiving the renewed vendor certificate, may install the renewed vendor certificate.

### TECHNICAL FIELD

Various examples for renewing a digital vendor certificate of a network device within a communication network, are described.

### BACKGROUND

A communication network may include a variety of network devices which may be interconnected and operating together to implement communication functions. Such network devices are generally developed and manufactured by a vendor organization. The vendor organization (referred to as a vendor) may then supply such network devices to a network operator. The vendor and the network operator may be different entities. When the network devices are delivered to the network operator, the network devices may then be integrated into the operator network in a secure manner, to ensure that the communication functions implemented thereafter, are secure and protected against intrusions. In an example, the secure integration of the network devices may be implemented through digital certificates. For example, the network devices may store digital vendor certificates which may be utilized by the network devices for requesting digital operator certificates. On the other hand, the digital operator certificates may be utilized for authenticating the operator network, when the network devices are connected to thereto.

The digital vendor certificates (referred to as vendor certificates) may be valid for a pre-defined time period. Once the pre-defined time period ends, the vendor certificates are to be renewed to ensure continuing communication functions. When the vendor certificates are renewed, the network devices may continue to service the communication network.

### BRIEF DESCRIPTION OF THE DRAWINGS

The following detailed description references the drawings, wherein:

FIG. 1 illustrates a network for renewing a digital vendor certificate of a network device, as per an implementation of the present subject matter;

FIG. 2 is a block diagram of an example network device to be implemented in the network, as per an implementation of the present subject matter;

FIG. 3 is a block diagram of an example centralized server to be implemented in the network, as per an implementation of the present subject matter;

FIG. 4 is an example call-flow diagram depicting various functionalities for renewing a digital vendor certificate of a network device over a communication network, as per an implementation of the present subject matter;

FIG. 5 is a flowchart depicting an example method to be implemented in a centralized server, for renewing a digital vendor certificate of a network device, as per an implementation of the present subject matter; and

FIG. 6 is a flowchart depicting an example method for renewing a vendor certificate of a network device, over a communication network, as per an implementation of the present subject matter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Communication networks may include a variety of network devices. The network devices, through their respective operations, may implement the desired network operations. The network devices, in turn, are manufactured and deployed by vendors. Examples of such communication network include, but are not limited to, Universal Mobile Telecommunications System (UMTS) for mobile communication networks based on the Global System for Mobile (GSM) communications standards, and other communication networks. The network may be controlled and managed by network operators. The network devices, when installed within the communication network, may rely on exchange of digital vendor certificates and digital operator certificates for integration, or for performing certain other operation functions. The digital operator certificates may be managed by the network operators over private networks. However, renewal of vendor certificates is generally undertaken by the vendor organization.

As may be understood, the vendor certificates of a given network device may be valid for a pre-defined time. If the pre-defined time is about to end, the vendor certificates may be renewed to ensure continuity in network operations. Renewing of the vendor certificates of a given network device is a time consuming and effort extensive exercise. For example, if the vendor and the operator are in agreement, and wish to extend the vendor certificate of the network device, the network device may have to be uninstalled and shipped to the vendor's facility for the vendor certificate to be renewed. Such a process is effort and cost extensive, and may, in certain cases, have an impact on network operations of the communication network.

Approaches for renewing a digital vendor certificate of a network device, over a communication network, are described. In an example, the network device may be in communication with a centralized server over the network. The centralized server may include root certificates and intermediate certificates, based on which any given vendor certificate may be renewed or generated. As will be explained, the centralized server may generate a new vendor certificate or renew an existing vendor certificate when a given vendor certificate of a network device is to expire.

The centralized server may authenticate the network device before a new vendor certificate may be generated. The network device may initially request for a new vendor certificate by way of a renewal request. In an example, the renewal request may include one or more device attributes corresponding to the network device. An example of device attributes may include, but is not limited to, a security device identity (SDI). In addition to the device attributes, the renewal request may further include the vendor certificate which is either about to expire or has expired. The renewal request may then be processed by the centralized server to authenticate the network device from which the renewal request has been received. On authenticating the request, the centralized server may generate a renewed vendor certificate. The renewed vendor certificate may then be shared with the network device, where it may be subsequently installed.

As may be understood, the above-described approaches allow the renewal of the vendor certificate without requiring the network device to be shipped to the premises of the vendors. The present approaches will enable the vendor certificate to be renewed over a communication network in an efficient and secure manner. Since the network device need not be shipped to the vendor premises, this would also reduce costs and other efforts that may entail for renewing the vendor certificate of the network device. The benefits may be further discernible in instances when a large number of network device may have to be updated. Relying on the present approaches, such large number of network devices may be updated seamlessly and efficiently.

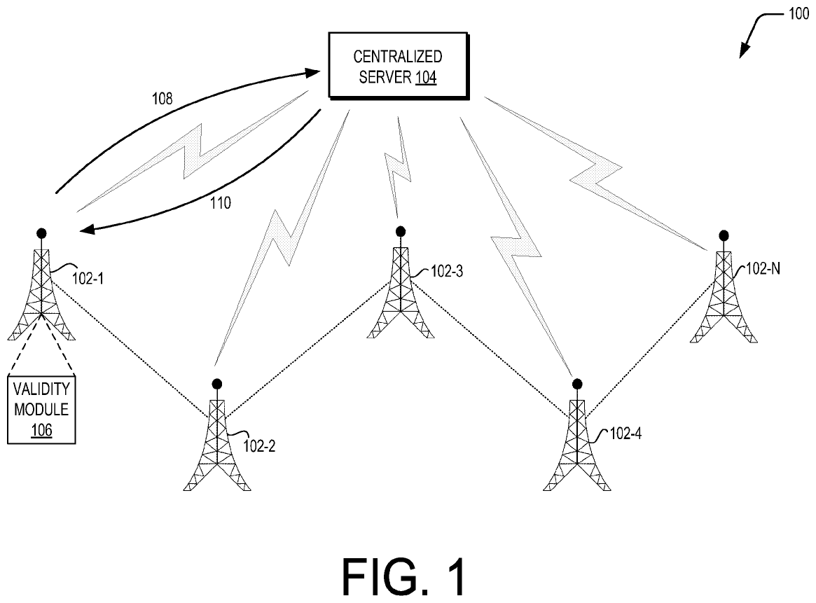

The manner in which the above-mentioned examples are implemented has been explained in detail with respect to FIGS. 1-6. While aspects of the present subject matter may be implemented in a variety of different communication systems, transmission environments, and/or configurations, the implementations are described in the context of the following system(s) as examples.

The terms during, while, and when as used herein are not exact terms that mean an action takes place instantly upon an initiating action but that there may be some small but reasonable delay, such as a propagation delay, between the initial action and the reaction that is initiated by the initial action. Additionally, the words “connected” and “coupled” are used throughout for clarity of the description and can include either a direct connection or an indirect connection. Various examples of the present subject matter have been described below by referring to several examples.

FIG. 1 illustrates a network 100, which enables renewing a digital vendor certificate of a network device, as per an implementation of the present subject matter. The network 100 includes a plurality of network devices 102-1, 102-2, . . . , 102-N (collectively referred to as network devices 102). Examples of such network devices 102 may include, but are not limited to, a base transceiver station, a mobile switching centre, base station controller, front haul switch, or any other component that may be used in the network 100. The network devices 102 may be further part of a telecommunication network (not shown in FIG. 1) which in turn may further include other entities, such as user equipments (UEs), etc. Such different devices may operate to perform various communication functions. Examples of such telecommunication network may include a Universal Mobile Telecommunications System (UMTS) for mobile communication networks based on the Global System for Mobile (GSM) communications standards, or any other network capable of connecting various components to implement communication functions. In an example, the network 100 may be implemented on such a telecommunication network.

The network 100 may further include a centralized server 104, to which each of the network devices 102 may be coupled to. The centralized server 104 may be implemented as any network-based hardware or software device capable of interacting over the network 100 with other network devices 102 in the network. The network devices 102, along with other components in the network 100 may be manufactured and deployed in the network 100 by different vendors. As would be understood, the network devices 102 operating in the network 100 may rely on exchange of digital certificates, for performing communication operations. Such certificates, as described previously, may be valid for a pre-defined time, and may have to be renewed, once the certificates expire.

In an example, each of the network devices 102 may further include a validity module 106. The validity module 106, amongst other aspects, may continuously monitor whether the certificates in the network devices 102 (hereinafter referred to as vendor certificates) are about to expire. If the vendor certificate within a given network device 102, say network device 102-1, is about to expire and is due for renewal, the validity module 106 may generate and transmit a renewal request 108 to the centralized server 104. In an example, the validity module 106 may generate the renewal request 108 based on one or more device attributes corresponding to the network devices 102 for which the vendor certificates are to be renewed. The present example approaches are described in the context of network device 102-1. Examples of such device attributes may include, but are not limited to, a security device identity (SDI), serial number, and geographical location where the network device 102-1 is installed. It may be noted that the examples of device attributes are only illustrative and should not be construed to limit the scope of the present subject matter. The validity module 106 may further include the vendor certificate of the network device 102-1, which is either about to or has already expired.

The centralized server 104, on receiving the renewal request 108 may process the request to initially authenticate the network device 102-1 from which the renewal request 108 has been received. The centralized server 104, after authenticating the network device 102-1 based on the renewal request 108, may generate a new vendor certificate or renew the existing vendor certificate, as received along with the renewal request 108. The renewed vendor certificate 110 may then be transmitted to the network device 102-1, where the same may be installed.

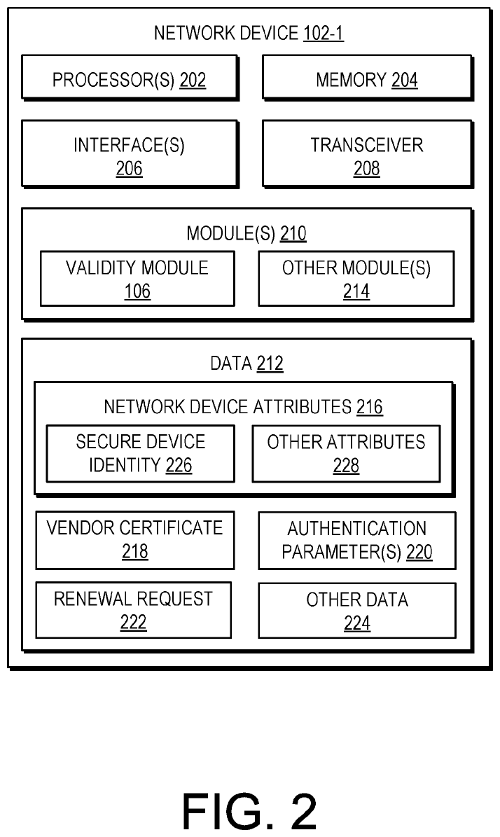

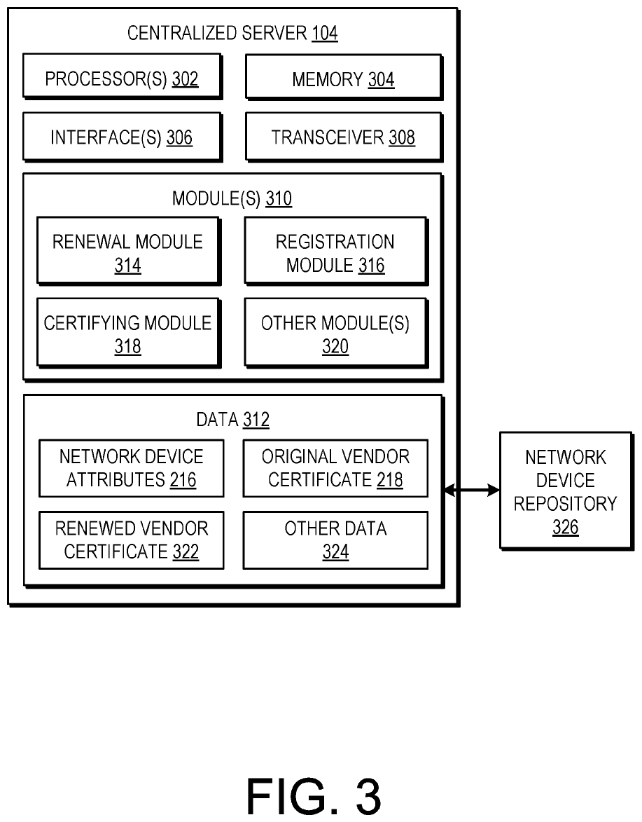

It may be noted that the centralized server 104 may further authenticate the request and generate the vendor certificate based on a set of root certificates and intermediate certificates, based on which the vendor certificate may be generated. In an example, the centralized server 104 may further include hardware or software for enabling certifying functions. For example, in the context of a public key infrastructure (PKI) based authenticating system, the centralized server 104 may enable functions of a registration authority (RA) and a certificate authority (CA). The manner in which such functions are implemented in the centralized server 104, along with the working of the network device 102-1, are further described in detail in conjunction with FIGS. 2-3.

FIG. 2 illustrates a block diagram of an example network device 102-1, to be implemented in the network 100, as per an implementation of the present subject matter. The network device 102-1 may be any network device capable of operating in the network 100. In the present example, the network device 102-1 includes processor(s) 202, memory 204, interface(s) 206, and transceiver 208. The processor(s) 202 may also be implemented as signal processor(s), state machine(s), and/or any other device or component that manipulate signals based on operational instructions. The memory 204 may store one or more executable instructions, which may be fetched and executed so as to perform one or more operations for renewing the digital vendor certificate of the network device 102-1. The memory 204 may also be used for storing data which may be generated or utilized during the operation of the network device 102-1. The memory 204 may be non-transitory computer-readable medium including, for example, volatile memory, such as RAM, or non-volatile memory such as EPROM, flash memory, and the like.

The interface(s) 206 may include a variety of interfaces, for example, interfaces for data input and output, and for exchanging a variety of operational instructions between other devices, such as the devices within the network 100. The interface(s) 206 may also be relied for implementing communication between the network device 102-1 and a centralized server 104, as depicted in FIG. 1. The interface(s) 206 may be implemented as either hardware or software. The transceiver 208 may be used by the network device 102-1 to transmit or receive data or signals, while communicating with other components in the network 100.

The network device 102-1 may further include module(s) 210 and data 212. The module(s) 210 may be implemented as a combination of hardware and programming (e.g., program instructions) to implement one or more functionalities of the network device 102-1. In one example, the module(s) 210 may include a validity module 106. The network device 102-1 may further include other module(s) 214 for implementing other functionalities. The data 212 includes information that may be utilized or generated by module(s) 210 during the course of operation of the network device 102-1. In one example, the data 212 includes network device attributes 216, vendor certificate 218 (which is to be renewed), authentication parameter(s) 220, renewal request 222 and other data 224. The network device attributes 216, in turn, may further include secure device identity 226 and other attributes 228.

In examples described herein, such combinations of hardware and programming may be implemented in a number of different ways. For example, the programming for the module(s) 210 may be by way of processor executable program instructions stored within a non-transitory machine-readable storage medium, and the hardware for the module(s) 210 may include processing resource (e.g., one or more processors), to execute such program instructions. In the present examples, the machine-readable storage medium may store program instructions that, when executed by the processing resource, implement the functionalities of module(s) 210. In such cases, the network device 102-1 may include the machine-readable storage medium storing the program instructions and the processing resource to execute the program instructions, or the machine-readable storage medium may be separate but accessible to network device 102-1 and the processing resource. In other examples, module(s) 210 may be implemented by an electronic circuitry.

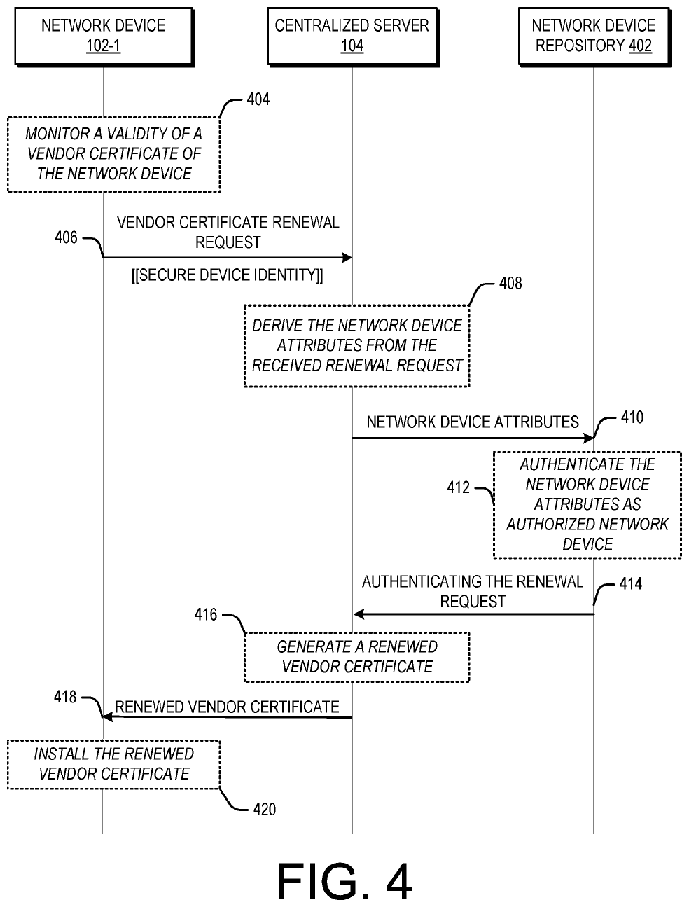

As will be explained, the renewal of a vendor certificate 218 of a network device, such as the network device 102-1, may be broadly considered to comprise at least a stage for generation of a renewal request, authenticating the renewal request, and subsequently generating the renewed vendor certificate. The operation of the network device 102-1 and the centralized server 104 is further explained in conjunction with a call flow diagram as illustrated in FIG. 4. FIG. 4 illustrates a call flow diagram depicting the interactions between the network device 102-1, centralized server 104 and a network device repository for renewing the digital vendor certificate of the network device 102-1.

The network device 102-1 provided by the vendor in the network 100, among other components, is configured to perform communication operations for a pre-defined period of agreement between the vendor and the operator. As mentioned previously, such agreements between the vendor and the operator may be implemented through the vendor certificates, valid for a pre-defined time. In operation, the validity module 106 may continuously monitor the validity of the vendor certificate 218 of the network device 102-1. Once the validity of the vendor certificate 218 of the network device 102-1 is about to lapse, the validity module 106 may notify the network device 102-1 and may request an operator for initiating a renewal of the vendor certificate 218. Upon determining that the vendor certificate 218 is to expire, the operator and the vendor may agree to an agreement to extend the validity of the vendor certificate 218 of the network device 102-1. The monitoring of the validity of the vendor certificate 218 of the network device 102-1 by the validity module 106 is represented by block 404 as depicted in FIG. 4.

In an example, the vendor, on agreeing to extend the validity of the network device 102-1, may provide the network device 102-1 with an authentication parameter 220. The authentication parameter 220 may correspond to the network device 102-1 requesting the renewal and may be used for establishing a secure connection between the network device 102-1 and the centralized server 104, for renewing the vendor certificate 218. Upon successfully establishing the secure connection between the network device 102-1 and the centralized server 104 (not shown in FIG. 2) over the network 100, the validity module 106 may then generate a renewal request 222. The renewal request 222 may comprise a set of network device attributes 216 and the vendor certificate 218 of the network device 102-1 which is either about to or has expired. In an example, the network device attributes 216 may include a secure device identity 226 of the network device 102-1. The renewal request 222 may further include other attributes 228 of the network device 102-1. Examples of other such attributes 228 may include, but are not limited to, serial number of the network device 102-1, and the geographical location where the network device 102-1 is installed. It may be noted that the examples of device attributes are only illustrative and should not be construed to limit the scope of the present subject matter.

In an example, the secure device identity (SDI) 226 of the network device 102-1 may comprise a combination of alphanumeric characters and may be issued to the network device 102-1 during its manufacturing in a secure manner. In such cases, the secure device identity 226 may act as a unique identifier of the network device 102-1. It may be noted that any other identifier which is cryptographically bound to a device and supports authentication of the device's identity may also be utilized without deviating from the scope of the present subject matter. In an example, the secure device identity 226 may be based on the IEEE 802.1AR-2018 Standard for Local and Metropolitan Area Networks.

Once the renewal request 222 is generated, the same may be transmitted by the transceiver 208 to the centralized server 104. The transmission of the renewal request 222 to the centralized server 104 by the transceiver 208 is represented by block 406 as depicted in FIG. 4. Thereafter, the centralized server 104 may process the renewal request 222 and may accordingly generate a renewed vendor certificate based on the received renewal request 222. The manner in which the vendor certificate is renewed by the centralized server 104 will be explained in further detail below, in conjunction with FIG. 3.

FIG. 3 illustrates a block diagram of an example centralized server 104, to be implemented in the network 100, as per an implementation of the present subject matter. In the present example, the centralized server 104 includes processor(s) 302, memory 304, interface(s) 306, and transceiver 308, which are similar to corresponding components of the network device 102-1, as depicted in FIG. 2. The centralized server 104 may further include module(s) 310 and data 312. In one example, the module(s) 310 include a renewal module 314, registration module 316, certifying module 318 and other module(s) 320 for implementing other functionalities. The data 312 includes information that may be utilized or generated by module(s) 310 during the course of operation of the centralized server 104. In one example, the data 312 includes network device attributes 216, original vendor certificate 218, renewed vendor certificate 322 and other data 324.

In operation, the centralized server 104 may receive a renewal request 222 from a network device 102-1, as described in FIG. 2 for renewing the vendor certificate of the network device 102-1. The centralized server 104, on receiving the renewal request 222, may process the received renewal request 222 to authenticate the network device 102-1.

As mentioned previously, the received renewal request 222 from the network device 102-1 may include a set of network device attributes 216 and the vendor certificate 218 (which is to be renewed) of the network device 102-1. In an example, the registration module 316 may derive the network device attributes 216 from the received renewal request 222. The network device attributes 216 may include a secure device identity (e.g., the secure device identity 226) and other attributes (such as the other attributes 228) corresponding to the network device 102-1. Examples of other such attributes 228 may include, but are not limited to, a serial number of the network device 102-1, and a geographical location where the network device 102-1 is installed. The deriving of the network device attributes from the renewal request 222 is represented by block 408, as depicted in FIG. 4.

Returning to the present example, the centralized server 104 may further be coupled to a network device repository 326 (depicted as network device repository 402 in FIG. 4). The network device repository 402 may include a list of the network devices 102 in the network 100, along with their corresponding network device attributes. During installation of a new network device in the network 100 by the vendor, the network device repository 402 may be updated to include the network device attributes of the installed network device. In this manner, the network device repository 402 may include an exhaustive list of all the authorized network devices in the communication network.

In an example, the network device repository 402 may further specify a validity status of each of the network devices 102 in the network 100. For example, it may be the case that certain network devices in the network 100 may be compromised or may have been rendered non-operational. In such cases, the validity status within the network device repository 402 may be updated. In an example, the centralized server 104 may further generate the vendor certificate of the network device 102-1 based on the validity status. An example table, Table 1 provided below, depicts the mapping of the various network device attributes with the validity status for the corresponding network device 102-1:

TABLE 1

| Serial | | Geographical | Validity |
|---|---|---|---|
| Number | SDI | Location | Status |
| LA20100001 | A1B1C1D1E1F1 | 60°12′24.7″N 24°39′07.2″E | Authorized |
| LB16200311 | A2B2C2D2E2F2 | 40°15′35.7″N 44°45′04.5″E | Un- |
| | | | authorized |
| LC17600005 | A3B3C3D3E3F3 | 32°72′52.7″N 64°15′03.9″E | Authorized |

It may be noted that the above example table is only illustrative and should not be considered to limit the scope of the present subject matter in any way. Other examples implementing such a similar table may be alternatively utilized without deviating from the scope of the present subject matter.

Returning to the present example, upon deriving the network device attributes 216 and the original vendor certificate 218 from the received renewal request 222, the registration module 316 may then authenticate the received renewal request 222 based on information received from the network device repository 402. The registration module 316 may compare at least one of the derived network device attributes 216 from the set of pre-defined network device attributes corresponding to the network devices data from the network device repository 402. As described previously, authenticating the renewal request 222 based on information received from the network device repository 402 may determine to ascertain whether the renewal request 222 was generated from an authorized network device 102-1 in the network. Further, the validity status of the network device in the network device repository 402 may further authenticate the network device making the renewal request 222. The transmission of the network device attributes 216 by the centralized server 104 to the network repository 402 and the authentication of the network device 102-1 by the registration module 316 are represented by blocks 410 and 412 respectively as depicted in FIG. 4.

Upon successful authentication of the network device 102-1 making the renewal request 222, the certifying module 318 may then generate a renewed vendor certificate 322 of the network device 102-1. It may be noted that, upon receiving a renewal request 222 from any network device 102, the registration module 316 authenticates the request, based on which the certifying module 318 generates a new or renews the existing vendor certificate. In an example, the registration module 316 of the centralized server 104 may be in communication with other components in the network 100. On the other hand, the certifying module 318 may be secured within the centralized server 104 and may only be accessed by the renewal module 314 after authentication of the received renewal request 222 from a network device 102 in the network 100 by the registration module 316. Since the certifying module 318 is not freely and openly accessible, the process of renewing the vendor certificate 218 is secure. The authentication of the renewal request 222 and generation of renewed vendor certificate 322 are represented by blocks 414 and 416 respectively as depicted in FIG. 4.

In an example, the vendor certificate renewal between the network device 102-1 and the centralized server 104 may be implemented using a public key infrastructure (PKI) based authenticating system. In such cases, the registration module 316 may be implemented as a registration authority

(RA) and the certifying module 318 may be implemented as a certificate authority (CA). The network device 102-1 may generate the renewal request 222 as a certificate signing request (CSR) including a public key of the network device 102-1. The centralized server 104, in response to the received certificate signing request, may authenticate the request and sign the certificate signing request with a private key of the centralized server.

Returning to the present example, after generating the renewed vendor certificate 322, the renewal module 314 may then cause the transceiver 308 to transmit the renewed vendor certificate 322 to the network device 102-1, from which the renewal request 222 has been received. The transmission of the renewed vendor certificate 322 by the transceiver 308 of the centralized server 104 to the network device 102-1 is represented by block 418 as depicted in FIG. 4. The network device 102-1 (not shown in FIG. 3), on receiving the renewed vendor certificate 322 may then install the renewed vendor certificate 322 and further discard the expired vendor certificate 218. The installation of the renewed vendor certificate 322 by the network device 102-1 is represented by block 420 as depicted in FIG. 4.

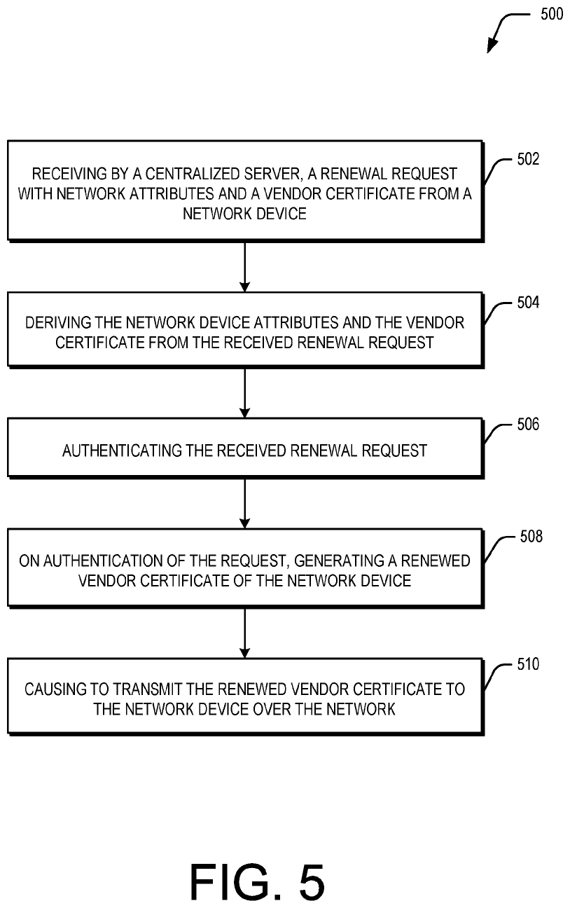

FIG. 5 illustrate example method 500, to be implemented in a centralized server, for renewing a digital vendor certificate of a network device, as per an implementation of the present subject matter. The order in which the method is described is not intended to be construed as a limitation, and any number of the described method blocks may be combined in any order to implement the aforementioned method, or an alternative method. Furthermore, method 500 may be implemented by processing resource or computing device(s) through any suitable hardware, non-transitory machine-readable program instructions, or combination thereof, or through logical circuitry.

It may also be understood that method 500 may be performed by programmed and/or configured network devices present within a network, with such devices including the centralized server 104 as depicted in FIGS. 1 and 3. Furthermore, in certain circumstances, program instructions stored in a non-transitory computer readable medium when executed may implement method 500 as will be readily understood. The non-transitory computer readable medium may include, for example, digital memories, magnetic storage media, such as one or more magnetic disks and magnetic tapes, hard drives, or optically readable digital data storage media. Although, the method 500 is described below with reference to the centralized server 104, as described above, other suitable systems for the execution of this method can be utilized. Additionally, implementation of this method is not limited to such examples.

At block 502, a centralized server may receive a renewal request from a network device which in turn includes network device attributes and a vendor certificate of the network device. For example, the centralized server 104 may receive a renewal request 222 from a network device 102-1, for renewing the vendor certificate 218 of the network device 102-1. The renewal request 222 may include a set of network device attributes 216 corresponding to the network device 102-1, and the vendor certificate 218 (which is to be renewed). In an example, the network device attributes 216 may include the secure device identity 226 and other attributes 228 of the network device 102-1.

At block 504, the network device attributes and the vendor certificate of the network device may be derived from the received renewal request. For example, the registration module 316 of the centralized server 104 may derive the network device attributes 216 and the original vendor certificate 218 of the network device 102-1 from the received renewal request 222. In an example, the network device attribute 216 may include a secure device identity (SDI) 226 of the network device 102-1.

At block 506, the received renewal request may be authenticated. For example, upon deriving the network device attributes 216 and the original vendor certificate 218 from the received renewal request 222, the registration module 316 may then authenticate the received renewal request 222 based on information received from the network device repository 402. The registration module 316 may compare at least one of the derived network device attributes 216 from a set of pre-defined network device attributes corresponding to the network devices data from the network device repository 402. The network device repository 402 may include a list of all the network devices 102 in the network 100, along with their corresponding network device attributes.

At block 508, on authentication of the request, a renewed vendor certificate of the network device may be generated. For example, upon successful authentication of the network device 102-1 making the renewal request 222, the certifying module 318 may then generate a renewed vendor certificate 322 of the network device 102-1.

At block 510, the renewed vendor certificate may be transmitted to the network device over the network. For example, after generating the renewed vendor certificate 322, the renewal module 314 may then cause the transceiver 308 to transmit the renewed vendor certificate 322 to the network device 102-1, from which the renewal request 222 has been received.

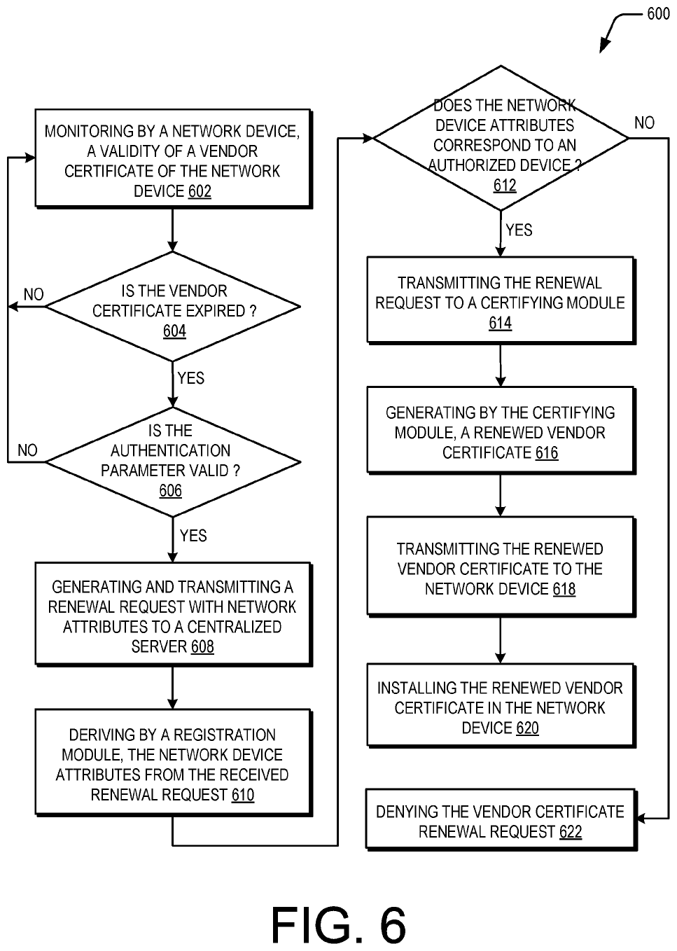

FIG. 6 depicts an example method 600 for renewing a digital vendor certificate of a network device, over a communication network, as per an implementation of the present subject matter.

At block 602, a network device may monitor a validity of a vendor certificate of the network device. For example, the vendor certificate 218 of the network device 102-1 provided by the vendor in the network 100, may be valid for a pre-defined period of time. The validity module 106 may continuously monitor the validity of the vendor certificate 218 of the network device 102-1.

At block 604, a determination may be made to ascertain whether the vendor certificate is expired or not. For example, the validity module 106 may determine if the pre-defined validity of the vendor certificate 218 of the network device 102-1 is about to lapse, and the vendor certificate 218 is about to expire. If the vendor certificate 218 of the network device 102-1 is valid (‘No’ path from block 604), the method 600 may loop back to block 602 and the validity module 106 may continue to monitor the validity of the vendor certificate 218 of the network device 102-1. However, if the vendor certificate 218 of the network device 102-1 is about to expire, or has already expired, (‘Yes’ path from block 604), the method may proceed to block 606.

At block 606, a further determination may be made to ascertain whether the authentication parameter is valid or not. For example, the validity module 106 on determining that the vendor certificate 218 of the network device 102-1 is about to expire, or has already expired, may request an operator for initiating a renewal of the vendor certificate 218. The vendor, on successfully agreeing to extend the validity of the network device 102-1, may provide the device with an authentication parameter 220. The authentication parameter 220 may correspond to the network device 102-1 requesting the renewal and may be used for establishing a secure connection between the network device 102-1 and the centralized server 104, for renewing the certificate. If the authentication parameter 220 is not valid (‘No’ path from block 606), the method 600 may loop back to block 602 and the validity module 106 may continue to monitor the validity of the vendor certificate 218 of the network device 102-1, without connecting to the centralized server 104. However, if the authentication parameter 220 is valid (‘Yes’ path from block 606), the method may proceed to block 608.

At block 608, a renewal request with network device attributes may be generated and transmitted to a centralized server. For example, upon successfully establishing the secure connection between the network device 102-1 and the centralized server 104, the validity module 106 may then generate a renewal request 222. The renewal request 222 may comprise a set of network device attributes 216 and the vendor certificate 218 of the network device 102-1 (which is to be renewed). In an example, the network device attributes 216 may include a secure device identity 226 of the network device 102-1. Thereafter, the validity module 106 may then cause the transceiver 208 to transmit the renewal request 222 to the centralized server 104.

At block 610, a registration module may derive the network device attributes from the received renewal request. For example, the centralized server 104 may receive the renewal request 222 from the network device 102-1. The received renewal request 222 may include a set of network device attributes 216 and the vendor certificate 218 of the network device 102-1. The registration module 316 may derive the network device attributes 216 from the received renewal request 222. The network device attributes 216 may include a secure device identity 226 and other attributes 228 of the network device 102-1. Examples of other such attributes may include, but are not limited to, a serial number of the network device 102-1, and a geographical location where the network device 102-1 is installed.

At block 612, a determination may be made to ascertain whether the derived network device attributes correspond to an authorized device in the network. For example, upon deriving the network device attributes 216 and the original vendor certificate 218 from the received renewal request 222, the registration module 316 may then authenticate the received renewal request 222 based on information received from a network device repository 402. The registration module 316 may compare at least one of the derived network device attributes 216 from a set of pre-defined network device attributes corresponding to the network devices data from the network device repository 402. The network device repository 402 may include a list of the network devices 102 in the network 100, along with their corresponding network device attributes and validity status. If the derived network device attributes 216 do not correspond to an authorized network device in the network (‘No’ path from block 612), the method may terminate to block 622. However, if the derived set of network device attributes 216 correspond to an authorized network device in the network (‘Yes’ path from block 612), the method may proceed to block 614.

At block 614, the renewal request may be transmitted to a certifying module. For example, upon successful authentication of the network device 102-1 making the renewal request 222, the renewal module 314 may then transmit the renewal request 222 to a certifying module 318. The certifying module 318 may be secured within the centralized server 104 and may only be accessed by the renewal module 314 after authentication of the received renewal request 222 from a network device 102 in the network 100. Only the registration module 316 of the centralized server 104 may be in communication with other components in the network 100.

At block 616, the certifying module may generate a renewed vendor certificate. For example, the certifying module 318 may then generate a renewed vendor certificate 322 of the network device 102-1.

At block 618, the renewed vendor certificate may be transmitted to the network device. For example, after generating the renewed vendor certificate 322, the renewal module 314 may then cause the transceiver 308 to transmit the renewed vendor certificate 322 to the network device 102-1, from which the renewal request 222 has been received.

At block 620, the renewed vendor certificate may be installed in the network device. For example, the network device 102-1, on receiving the renewed vendor certificate 322 may then install the renewed vendor certificate 322 and further discard the expired vendor certificate 218.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1-15. (canceled)

16. An apparatus comprising:
at least one a processor; and at least one memory storing instructions that, when executed by the at least one processor, cause the apparatus at least to:
receive a renewal request from a network device, wherein the renewal request comprises a plurality of network device attributes and a vendor certificate of the network device;
derive the network device attributes and the vendor certificate from the renewal request;
authenticate the received renewal request;
based on the authentication of the received renewal request, generate a renewed vendor certificate; and
cause to transmit the renewed vendor certificate to the network device over the communication network.

17. The apparatus of claim 16, wherein the plurality of the network device attributes comprises a secure device identity, a serial number, and geographical location of the network device.

18. The apparatus of claim 16, wherein the centralized server is to authenticate the received renewal request based on information received from a network device repository.

19. The apparatus of claim 18, wherein the network device repository comprises a list of network devices in the network along with their corresponding network device attributes.

20. The apparatus of claim 16, wherein the apparatus is further caused to:
compare the derived network device attributes with network device attributes corresponding to the network devices data from the network device repository; and
based on the comparison, authenticate the renewal request.

21. The apparatus of claim 20, wherein the apparatus is further caused to:
receive from the registration module, an authenticated renewal request of the network device; and generate the renewed vendor certificate of the network device.

22. A network device comprising:
at least one processor; and at least one memory storing instructions that, when executed by the at least one processor, cause the network device at least to:
monitor a validity of a vendor certificate of a network device;
generate a renewal request, wherein the renewal request comprises a plurality of network device attributes and the vendor certificate of the network device; and
transmit the renewal request to a centralized server in communication with the network device over a communication network.

23. The network device as claimed in claim 22, wherein the network device is further caused to:
receive an authentication parameter, wherein the authentication parameter is to establish a secure connection between the network device and the centralized server.

24. The network device as claimed in claim 22, wherein the network device is further caused to, upon receiving a renewed vendor certificate from the centralized server, discard the expired vendor certificate and install the renewed vendor certificate in the network device.

25. The network device as claimed in claim 22, wherein the network device is one of a base transceiver station, mobile switching center base station controller and a front haul switch.

26. The network device as claimed in claim 22, wherein the vendor certificate to be renewed over the communication network is implemented using a public key infrastructure architecture.

27. A method comprising:
receiving by a centralized server, a renewal request from a network device for renewing a vendor certificate of the network device over a communication network, wherein the renewal request comprises a plurality of network device attributes and a vendor certificate of the network device;
deriving the network device attributes and the vendor certificate from the renewal request;
authenticating the received renewal request;
based on the authentication of the received renewal request, generating a renewed vendor certificate; and causing to transmit the renewed vendor certificate to the network device over the communication network.

28. The method as claimed in claim 27, wherein the plurality of the network device attributes comprises a secure device identity, serial number, and geographical location of the network device.

29. The method as claimed in claim 27, further comprising steps of:
comparing at least one of the derived network device attributes with the network device attributes corresponding to the data of network devices from the network device repository; and
based on the comparison, authenticating the renewal request.

30. The method as claimed in claim 29, further comprising steps of:
receiving from the registration module, an authenticated renewal request of the network device; and generating the renewed vendor certificate of the network device.
